(19) United States
(12) Patent Application Publication
(10) Pub. No.: US 2026/0079694 A1
(43) Pub. Date: Mar. 19, 2026

(54) TECHNIQUES FOR PERFORMING SOFTWARE UPDATES

(71) Applicant: TEXAS INSTRUMENT INCORPORATED, Dallas, TX (US)

(72) Inventors: Yossi Bouskila, Ramat-Gan (IL); Barak Cherches, Ramat-Hakovesh (IL)

(21) Appl. No.: 19/328,899

(22) Filed: Sep. 15, 2025

Related U.S. Application Data
(60) Provisional application No. 63/695,402, filed on Sep. 17, 2024.

(51) Int. Cl. G06F 8/654

(52) U.S. Cl. CPC G06F 8/654

(57) ABSTRACT

Various embodiments of the present disclosure relate to updating software. In one example embodiment, a technique for performing OTA updates that optimizes the available memory space is provided. The technique first includes executing an application from non-volatile memory, such that a first portion of the application is stored in a first region of non-volatile memory and a second portion of the application is stored in a second region of non-volatile memory. Next, the technique includes receiving an updated first portion of the application and overwriting the second region with the updated first portion. Once overwritten, the technique includes swapping the first portion with the updated first portion. Next, the technique includes receiving an updated second portion of the application and overwriting the second region with the updated second portion. Finally, the technique includes executing the application from non-volatile memory.

### CROSS-REFERENCE TO RELATED APPLICATION

This application is related to, and claims the benefit of priority to, U.S. Provisional Ser. No. 63/695,402 , filed on Sep. 17, 2024, and entitled “OVER-THE-AIR SOFTWARE UPDATES”, which Application is hereby incorporated by reference in its entirety.

### TECHNICAL FIELD

Aspects of the disclosure are related to software updates, and in particular, to methods for performing over-the-air (OTA) software updates that optimize the available space in memory.

### BACKGROUND

Over-the-air (OTA) software updates provide a mechanism for remotely updating the firmware, application software, or configuration data of a device. For example, OTA software updates are delivered from a source to the device via a wireless communication network, such as Wi-Fi™, Bluetooth, cellular, or other suitable wireless protocols. OTA updates may be performed on devices that utilize non-volatile memory. For example, such devices include microcontroller units (MCUs) that use internal or external flash memory.

### SUMMARY

Disclosed herein is technology, including systems, methods, and devices for performing software updates that maximizes the available space in the associated memory.

In one example embodiment, a method for updating software by one or more cores of a computing device is provided. In an implementation, the method first includes executing an application from a non-volatile memory of the computing device, such that a first portion of the application is stored in a first region of the non-volatile memory and a second portion of the application is stored in a second region of the non-volatile memory. Next, the method includes receiving an updated version of the first portion of the application and overwriting the second region with the updated version of the first portion of the application. Once overwritten, the method includes swapping the first portion of the application with the updated version of the first portion of the application. For example, the method includes storing the first portion of the application in the second region and storing the updated version of the first portion of the application in the first region. Next, the method includes receiving an updated version of the second portion of the application and overwriting the second region with the updated version of the second portion of the application. Finally, the method includes executing the application from the non-volatile memory, such that the updated version of the first portion of the application is stored in the first region and the updated version of the second portion of the application is stored in the second region.

In a second example embodiment, a system comprising non-volatile memory having a first region configurable to store a first portion of an application and a second region configurable to store a second portion of the application, transceiver circuitry coupled to the non-volatile memory, and processing circuitry coupled to the transceiver circuitry and the non-volatile memory is provided. In an implementation, the processing circuitry is configured to execute the application from the non-volatile memory. Next, the processing circuitry is configured to, in response to the transceiver circuitry receiving an updated version of the first portion of the application and providing the updated version of the first portion of the application to the processing circuitry, overwrite the second region with the updated version of the first portion of the application. Once overwritten, the processing circuitry is configured to swap the first portion of the application with the updated version of the first portion of the application. For example, the processing circuitry is configured to store the first portion of the application in the second region and store the updated version of the first portion of the application in the first region. Next, the processing circuitry is configured to, in response to the transceiver circuitry receiving an updated version of the second portion of the application and providing the updated version of the second portion of the application to the processing circuitry, overwrite the second region with the updated version of the second portion of the application. Finally, the processing circuitry is configured to execute the application from the non-volatile memory, such that the updated version of the first portion of the application is stored in the first region and the updated version of the second portion of the application is stored in the second region.

In a third example embodiment, a non-transitory computer-readable medium having program instructions stored thereon, configured to be executable by processing circuitry is provided. In an implementation, the program instructions, when executed by the processing circuitry, cause the processing circuitry to initiate an update process. Next, the program instructions cause the processing circuitry to, in response to initiating the update process, delete a second portion of an application from a second region of non-volatile memory and download an updated version of a first portion of the application to the second region of non-volatile memory. Once downloaded, the program instructions cause the processing circuitry to swap the first portion of the application, currently stored in a first region of non-volatile memory, with the updated version of the first portion of the application. For example, the program instructions cause the processing circuitry to store the first portion of the application in the second region of non-volatile memory and store the updated version of the first portion of the application in the first region of non-volatile memory. Finally, the program instructions cause the processing circuitry to delete the first portion of the application from the second region of non-volatile memory and download an updated version of the second portion of the application to the second region of non-volatile memory.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system in an implementation.

FIG. 2 illustrates a software update method in an implementation.

FIG. 3 illustrates a sequence diagram in an implementation.

FIGS. 4A and 4B illustrate operational scenarios in various implementations.

FIGS. 5A-5E illustrate another over-the-air software update method in an implementation.

### DETAILED DESCRIPTION

Systems, methods, and devices are disclosed herein that provide a method for updating software. The disclosed technique(s) may be implemented in the context of hardware, software, firmware, or a combination thereof to provide a technique that enables a system to perform software updates without dedicating a specific region in memory to the update. Advantageously, the proposed technology maximizes the available space in memory while ensuring reliability throughout the update process.

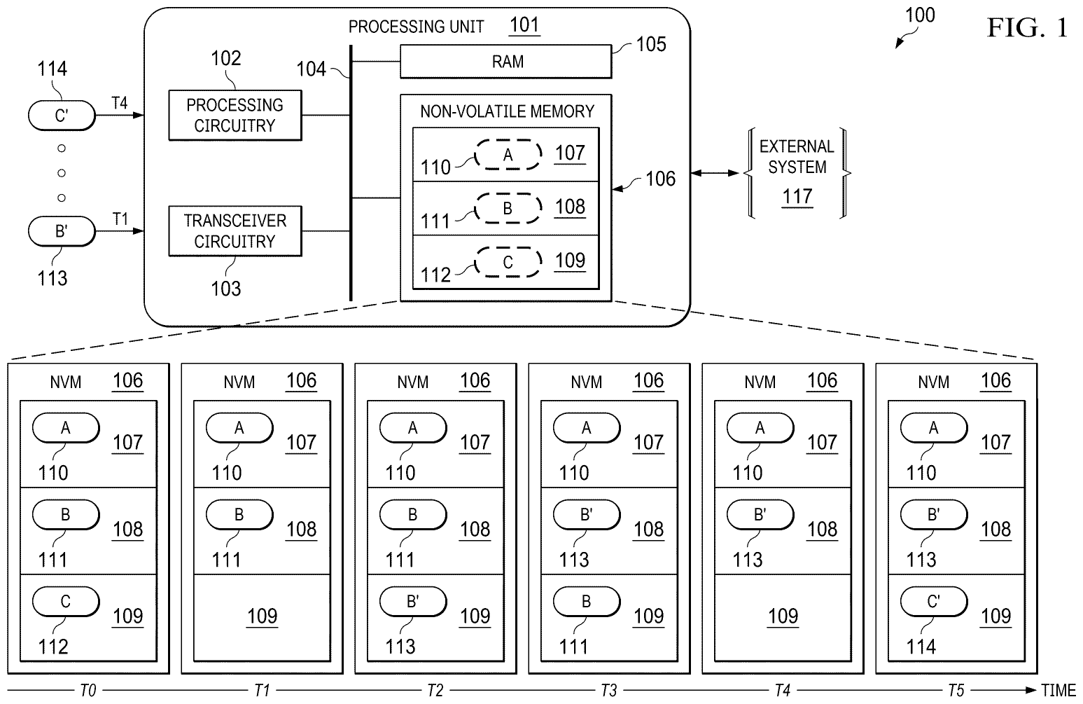

FIG. 1 illustrates system 100 in an implementation. System 100 is representative of an exemplary environment for performing over-the-air (OTA) software updates. For example, system 100 depicts a processing unit capable of receiving software updates over a communication network, such as Wi-Fi™, Bluetooth, cellular, or another wireless protocol of the like. Although, it should be noted that system 100 is also capable of receiving software updates over wired communication protocols, such as Ethernet, Controller Area Network (CAN), Universal Serial Bus (USB), or other interfaces of the like. For the purposes of explanation, system 100 will be explained as a processing unit configured to perform OTA software updates. This is not meant to limit the applications of system 100, but rather to provide an example. System 100 includes, but is not limited to, processing unit 101 and external system 117.

Processing unit 101 is representative of circuitry that manages the operations of system 100. For example, processing unit 101 depicts one or more cores of a central processing unit (CPU), microcontroller unit (MCU), application specific integrated circuit (ASIC), or another general-purpose processor (GPP) of the like that is configured to manage the operations of external system 117. In an implementation, processing unit 101 communicates with a source to receive OTA software updates. For example, processing unit 101 may communicate with a server that stores the software updates. Processing unit 101 includes, but is not limited to, processing circuitry 102, transceiver circuitry 103, bus 104, random access memory (RAM) 105, and non-volatile memory 106.

Processing circuitry 102 is representative of circuitry that manages the operations of processing unit 101. For example, processing circuitry 102 depicts one or more cores of a CPU, MCU, ASIC, or another GPP of the like that executes software from memory. In an implementation, processing circuitry 102 initiates the OTA software update process. For example, when triggered, processing circuitry 102 updates the software stored by non-volatile memory 106. In an implementation, processing circuitry 102 interfaces with transceiver circuitry 103 to perform the OTA software update.

Transceiver circuitry 103 is representative of circuitry that transmits and receives data over a wireless communication network. For example, transceiver circuitry 103 facilitates the communication of data across networks such as Wi-Fi™, Bluetooth, cellular, or another suitable wireless protocol of the like. In an implementation, when directed by processing circuitry 102, transceiver circuitry 103 outputs an OTA update request to an associated system. For example, when triggered by processing circuitry 102, transceiver circuitry 103 outputs the OTA update request to a server, cloud-based system, gateway, or another device of the like capable of transmitting data over the network. In an implementation, transceiver circuitry 103 communicates with processing circuitry 102 via bus 104.

Bus 104 is representative of circuitry that facilitates communication across the components of processing unit 101. For example, bus 104 depicts an interconnect, event fabric, or another data bus of the like that enables the transfer of data between processing circuitry 102, transceiver circuitry 103, RAM 105, and non-volatile memory 106.

RAM 105 is representative of a memory that stores instructions, data, and the like for the components of processing unit 101. For example, processing circuitry 102 reads from and writes to RAM 105 to execute software, temporarily store computation results, and manage system operations. It should be noted that RAM 105 is not limited to representing random access memory, and is instead representative of any type of volatile memory, including dynamic RAM (DRAM), static RAM (SRAM), or another volatile memory of the like. Additionally, it should be noted that, in no case is RAM 105 representative of a propagated signal.

Non-volatile memory 106 is representative of another memory that stores instructions, data, and the like for the components of processing unit 101. For example, non-volatile memory 106 is representative of a non-transitory computer-readable medium storing program instructions thereon. More specifically, non-volatile memory 106 is representative of an internal flash memory that stores software which may be executed directly from non-volatile memory 106 and is tailored to the functional requirements of processing unit 101. For example, if external system 117 is representative of an automotive system, then non-volatile memory 106 stores application software related to vehicle control, diagnostics, and other automotive functions. As such, the application software stored in non-volatile memory 106 allows processing unit 101 to control the operations of external system 117 (e.g., industrial system, consumer electronic, medical system, etc.).

In an implementation, the software stored in non-volatile memory 106 is organized via binary codes to position the components required for performing OTA software updates in the first half of the memory. For example, the first half of non-volatile memory 106 stores the communication software that allows transceiver circuitry 103 to interface with external components while the second half of non-volatile memory 106 stores the user software that is application specific. Non-volatile memory 106 includes, but is not limited to, regions 107, 108, and 109. It should be noted that, while illustrated as an on-chip memory, non-volatile memory 106 may be representative of an off-chip memory, such as external flash memory. Additionally, it should be noted that, in no case is non-volatile memory 106 representative of a propagated signal.

Regions 107, 108, and 109 are representative of distinct sections in memory that are dedicated to storing program code. Specifically, region 107 corresponds to a first address space within non-volatile memory 106, region 108 corresponds to a second address space within non-volatile memory 106, and region 109 corresponds to a third address space within non-volatile memory 106. In an implementation, region 107 is dedicated to storing program code that is related to system initialization, region 108 is dedicated to storing program code that is useful for performing the OTA software update, and region 109 is dedicated to storing the remaining program code. For example, the program code stored by non-volatile memory 106 is organized in a manner that causes region 107 to store the bootloader, region 108 to store the communication software that allows for communication with external components, and region 109 to store the user software that is MCU-specific. As such, region 107 includes module 110, region 108 includes module 111, and region 109 includes module 112.

Modules 110, 111, and 112 are representative of software components that provide functionality to the hardware components of processing unit 101. For example, module 110 is representative of a bootloader that allows processing circuitry 102 to initialize processing unit 101, module 111 is representative of a management module (MM) that allows processing circuitry 102 to perform the OTA update process, and module 112 is representative of a functional module (FM) that allows processing circuitry 102 to perform application specific functions. As such, modules 110, 111, and 112 represent program code that is executable by the circuitries of processing unit 101, such that modules 111 and 112 respectively represent the first and second portions of an application. In an implementation, module 111 includes multiple software components that are required for performing the OTA update process. For example, module 111 includes control software that causes processing circuitry 102 to initiate the OTA update process and communication software that allows transceiver circuitry 103 to receive software updates across a wireless network. Alternatively, module 112 includes multiple software components that are not required for the OTA update process. For example, module 112 includes user software that allows processing unit 101 to control external system 117. Additionally, it should be noted that, module 110 may be stored in an alternative memory, but for the purposes of explanation, module 110 will be explained as being stored in non-volatile memory 106. This specification is not meant to limit the applications of the proposed technology, but rather, to provide an example.

During operation, processing circuitry 102 may remotely update any of modules 110, 111, and 112. For example, when triggered, processing circuitry 102 replaces any of modules 110, 111, and 112 with an updated version of the respective module. For the purposes of explanation, processing circuitry 102 will be explained as capable of updating modules 111 and 112. This specification is not meant to limit the applications of the proposed technology, but rather, to provide an example.

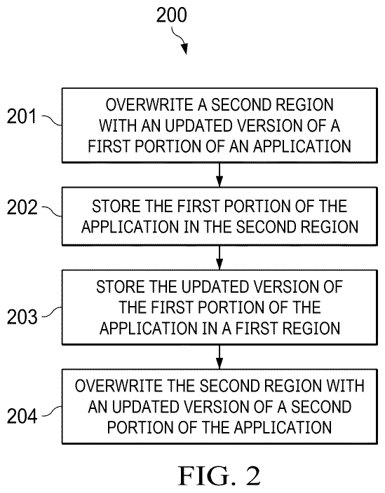

Now turning to the next figure, FIG. 2 illustrates method 200 in an implementation. Method 200 is representative of a technique for updating software while maximizing the available space in memory. Method 200 may be implemented in the context of hardware, firmware, or software to cause a system to operate as follows, referring parenthetically to the steps in FIG. 2. For the purposes of explanation, method 200 will be explained with respect to the elements of FIG. 1. This specification is not meant to limit the applications of method 200, but rather to provide an example.

To begin, at time T0, processing circuitry 102 is triggered to initiate the OTA update process with respect to the application stored by non-volatile memory 106. For example, a user may instruct processing circuitry 102 to perform the update by selecting an update option within a companion mobile application, confirming an update prompt presented on a display, activating a dedicated hardware button, or issuing an update command over a communication interface such as Wi-Fi™, Bluetooth, or UART. In response, processing circuitry 102 initiates the OTA update process. In an implementation, to initiate the OTA update process, processing circuitry 102 executes the control software of module 111. For example, when executed by processing circuitry 102, the control software of module 111 causes processing circuitry 102 to instruct transceiver circuitry 103 to output an OTA request for updating module 111. In response, transceiver circuitry 103 utilizes the communication software of module 111 to transmit the OTA request to the external component (e.g., server) that is storing the updated application.

Next, between the duration of time T1 and time T2, processing circuitry 102 overwrites region 109 with module 113 (step 201). Module 113 is representative of the updated version of module 111. As such, module 113 includes, but is not limited to, updated control software and updated communication software. In an implementation, to overwrite region 109 with module 113, processing circuitry 102 deletes module 112 from region 109 and subsequently stores module 113 in region 109. For example, at time T1, processing circuitry 102 erases module 112 from region 109 and transceiver circuitry 103 receives module 113 across the wireless communication network and provides module 113 to processing circuitry 102. In response, processing circuitry 102 temporarily stores module 113 in an associated memory. For example, in response to receiving module 113, processing circuitry 102 stores module 113 in RAM 105. Alternatively, processing circuitry 102 may store module 113 in its buffer. In either case, at time T2, processing circuitry 102 transfers module 113 from the associated memory to region 109. It should be noted that, module 113 may be delivered across the wireless network in portions. For example, if module 113 is to be temporarily stored in a memory with limited space, then module 113 is delivered across the network in portions that are equal to or smaller than the available memory capacity.

Next, processing circuitry 102 authenticates module 113. For example, processing circuitry 102 determines if module 113 includes the software components that support communications with external components. Once successfully authenticated, at time T3, processing circuitry 102 swaps module 111 with module 113. For example, processing circuitry 102 stores module 113 in a temporary location (e.g., the buffer of processing circuitry 102 or RAM 105), and stores module 111 in region 109 (step 202). Once stored, processing circuitry 102 transfers module 113 from the temporary location to region 108 (step 203). Next, processing circuitry 102 begins executing the updated control software of module 113 to begin the next phase of the OTA update process. For example, when executed by processing circuitry 102, the updated control software of module 113 causes processing circuitry 102 to instruct transceiver circuitry 103 to output an OTA request for updating module 112. In response, transceiver circuitry 103 utilizes the updated communication software of module 113 to transmit the OTA request to the external component that is storing the updated application.

Next, between the duration of time T4 and time T5, processing circuitry 102 overwrites region 109 with module 114 (step 204). Module 114 is representative of the updated version of module 112. As such, module 114 includes, but is not limited to, updated user software. In an implementation, to overwrite region 109 with module 114, processing circuitry 102 deletes module 111 from region 109 and subsequently downloads module 114 to region 109. For example, at time T4, processing circuitry 102 erases module 111 from region 109 and transceiver circuitry 103 receives module 114 across the wireless communication network and provides module 114 to processing circuitry 102. In response, processing circuitry 102 temporarily stores module 114 in an associated memory. For example, in response to receiving module 114, processing circuitry 102 stores module 114 in RAM 105 or its own buffer. Once stored, at time T5, processing circuitry 102 transfers module 114 from the associated memory to region 109. It should be noted that, module 114 may be delivered across the wireless network in portions. For example, if module 114 is to be temporarily stored in a memory with limited availability, then module 114 is delivered across the network in portions that are equal to or smaller than the available memory capacity.

Finally, processing circuitry 102 authenticates the updated application. For example, processing circuitry 102 checks if modules 113 and 114 include the components for providing the desired functionality to system 100.

Advantageously, method 200 provides a technique for performing software updates without requiring a region in memory to be dedicated to receiving the updated software. As such, method 200 provides a technique for performing OTA software updates the optimizes the available space in memory.

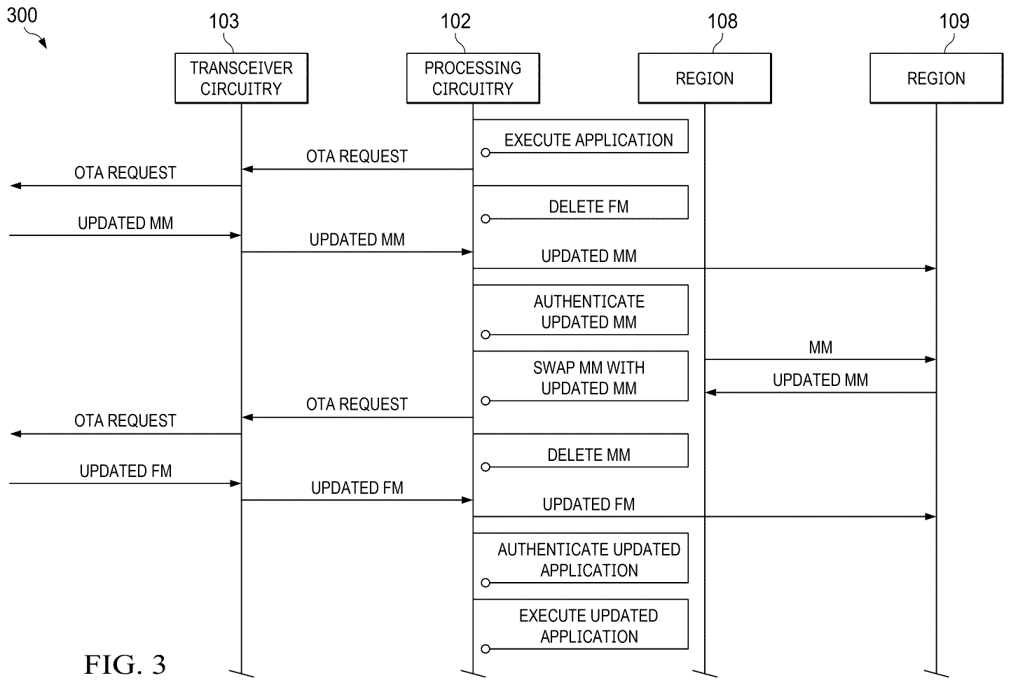

FIG. 3 illustrates sequence diagram 300 in an implementation. Sequence diagram 300 is representative of an operational sequence for performing OTA software updates. For the purposes of explanation, sequence diagram 300 will be explained with reference to FIG. 1. This specification is not meant to limit the applications of sequence diagram 300, but rather, to provide an example. Sequence diagram 300 includes transceiver circuitry 103, processing circuitry 102, region 108, and region 109.

To begin, processing circuitry 102 executes the application stored by non-volatile memory 106 (time T0). For example, processing circuitry 102 executes module 111 from region 108 and module 112 from region 109. Next, processing circuitry 102 is triggered to output an OTA request for updating the management module of the application. For example, when triggered by an associated user, the control software of module 111 causes processing circuitry 102 to delete module 112 from region 109 (time T1) and instruct transceiver circuitry 103 to output an OTA request for updating module 111. In response, transceiver circuitry 103 generates the OTA request and transmits the request across a wireless network to the external component storing the updated application. Next, transceiver circuitry 103 receives module 113 from the external component and provides module 113 to processing circuitry 102. In response, processing circuitry 102 stores module 113 in a temporary memory (e.g., RAM 105).

Next, processing circuitry 102 transfers module 113 to region 109 (time T2) and responsively authenticates module 113. For example, processing circuitry 102 checks if module 113 includes the software components for continuing the OTA update process. More specifically, processing circuitry 102 checks if module 113 includes the appropriate communication software for interfacing with external components. Once authenticated, processing circuitry 102 swaps module 111 with module 113 (time T3). For example, processing circuitry 102 stores module 111 in region 109 and stores module 113 in region 108. More specifically, processing circuitry 102 stores module 113 in a temporary location, such as RAM 105, and transfers module 111 from region 108 to region 109. Once transferred, processing circuitry 102 transfers module 113 from the temporary location to region 108. Processing circuitry 102 then begins executing the updated control software of module 113, which causes processing circuitry 102 to delete module 111 from region 109 (time T4) and instruct transceiver circuitry 103 to output an OTA request for updating the functional module (i.e., module 112) of the application.

Once instructed, transceiver circuitry 103 generates the OTA request for updating module 112 and transmits the request to the external component via the wireless network. In response, transceiver circuitry 103 receives module 114 from the external component and provides module 114 to processing circuitry 102. Once received, processing circuitry 102 stores module 114 in a temporary memory location. Next, processing circuitry 102 transfers module 114 to region 109 (time T5) and responsively authenticates the updated application. For example, processing circuitry 102 checks if modules 113 and 114 include the components for providing the desired functionality to system 100. Once authenticated, processing circuitry 102 executes the updated application stored by non-volatile memory 106. For example, processing circuitry 102 executes module 113 from region 108 and module 114 from region 109.

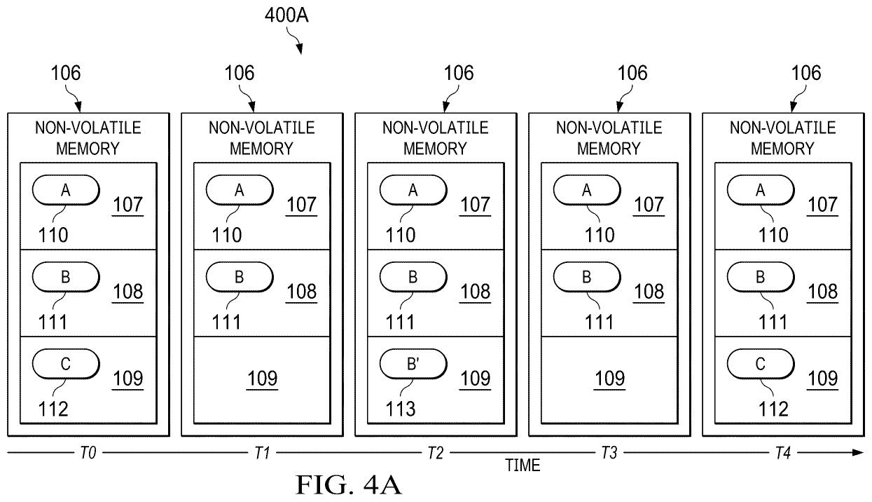

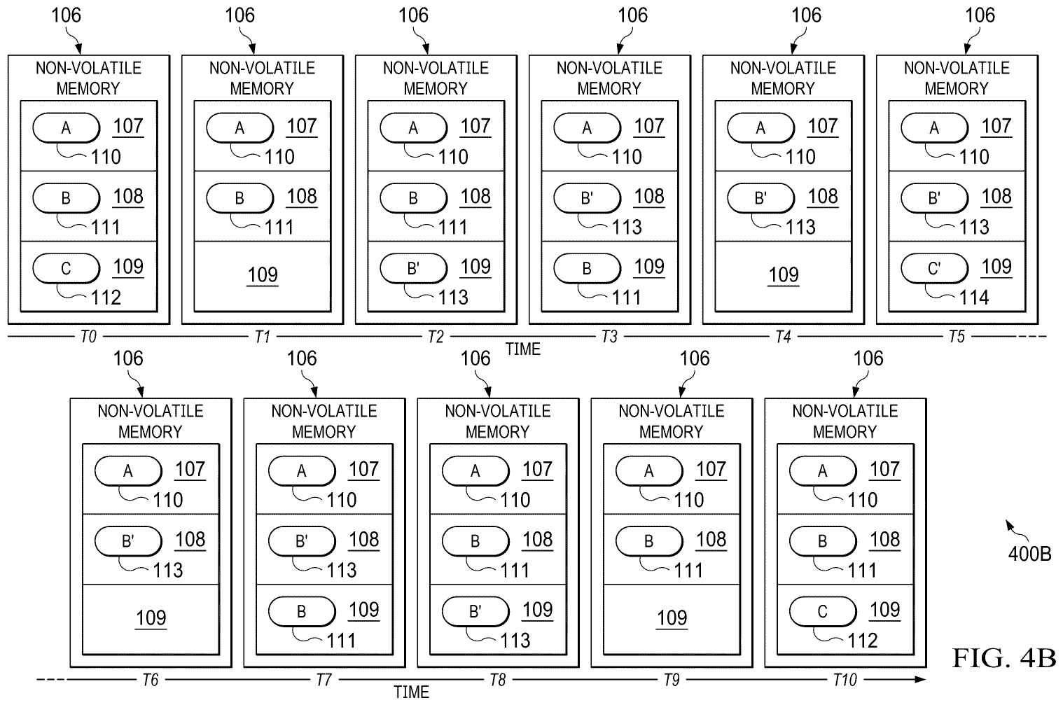

FIGS. 4A and 4B respectively illustrate operational scenarios 400A and 400B in an implementation. Operational scenario 400A is representative of a scenario for when processing circuitry 102 fails to authenticate module 113, while operational scenario 400B is representative of a scenario for when processing circuitry 102 fails to authenticate the updated application.

Now turning to operational scenario 400A, to begin, processing circuitry 102 initiates the OTA update process and instructs transceiver circuitry 103 to output an OTA request for updating module 111 (time T0). Next, after receiving module 113 from transceiver circuitry 103, processing circuitry 102 stores module 113 in a temporary memory location, deletes module 112 from region 109 (time T1), and downloads module 113 to region 109 (time T2). Once downloaded, processing circuitry 102 attempts to authenticate module 113. For example, processing circuitry 102 checks if module 113 includes the communication software that allows for communication with external components.

In response to unsuccessfully authenticating module 113, processing circuitry 102 deletes module 113 from region 109 (time T3) and instructs transceiver circuitry 103 to output a request for restoring module 112. Next, after receiving module 112 from transceiver circuitry 103, processing circuitry 102 stores module 112 in region 109 (time T4) and returns to executing module 111 from region 108 and module 112 from region 109.

Turning now to operational scenario 400B, to begin, processing circuitry 102 initiates the OTA update process and instructs transceiver circuitry 103 to output an OTA request for updating module 111 (time T0). Next, after receiving module 113 from transceiver circuitry 103, processing circuitry 102 stores module 113 in a temporary location, deletes module 112 from region 109 (time T1), and stores module 113 in region 109 (time T2). Once stored, processing circuitry 102 attempts to authenticate module 113. For example, processing circuitry 102 checks if the updated communication software of module 113 supports the wireless protocol that transceiver circuitry 103 uses to interface with external components. In response to successfully authenticating module 113, processing circuitry 102 swaps module 111 with module 113 (time T3). For example, processing circuitry 102 stores module 113 in an associated memory and transfers module 111 from region 108 to region 109. Once transferred, processing circuitry 102 transfers module 113 from the associated memory to region 108.

Processing circuitry 102 then instructs transceiver circuitry 103 to output an OTA request for updating module 112. Next, after receiving module 114 from transceiver circuitry 103, processing circuitry 102 stores module 114 in a temporary location, deletes module 111 from region 109 (time T4) and stores module 114 in region 109 (time T5). Once stored, processing circuitry 102 attempts to authenticate the updated application. For example, processing circuitry 102 checks if modules 113 and 114 include the components for providing the desired functionality to system 100. In response to unsuccessfully authenticating the updated application, processing circuitry 102 deletes module 114 from region 109 (time T6) and instructs transceiver circuitry 103 to output a request for restoring module 111.

Next, after receiving module 111 from transceiver circuitry 103, processing circuitry 102 stores module 111 in region 109 (time T7) and swaps module 113 with module 111 (time T8). For example, processing circuitry 102 stores module 111 in an associated memory and transfer module 113 from region 108 to region 109. Once transferred, processing circuitry 102 transfer module 111 from the associated memory to region 108. Processing circuitry 102 then instructs transceiver circuitry 103 to output a request for restoring module 112. Next, after receiving module 112 from transceiver circuitry 103, processing circuitry 102 stores module 112 in a temporary location, deletes module 113 from region 109 (time T9), and stores module 112 in region 109 (time T10). Once stored, processing circuitry 102 returns to executing module 111 from region 108 and module 112 from region 109.

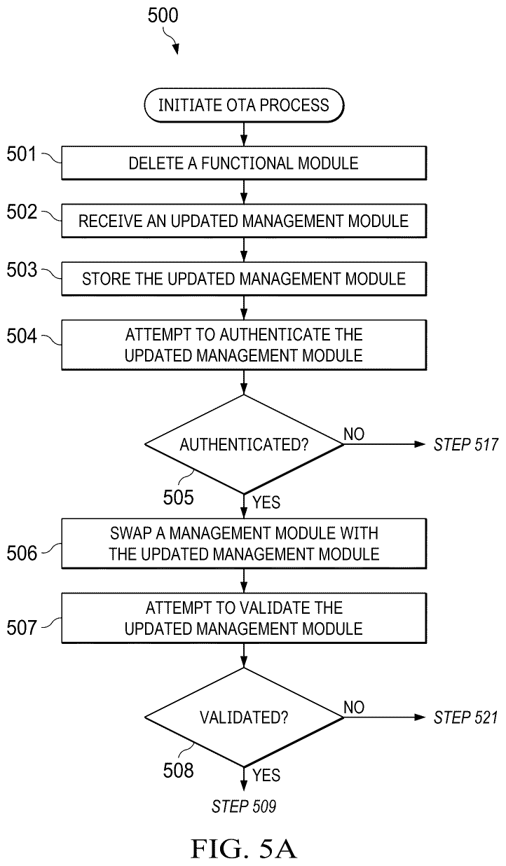

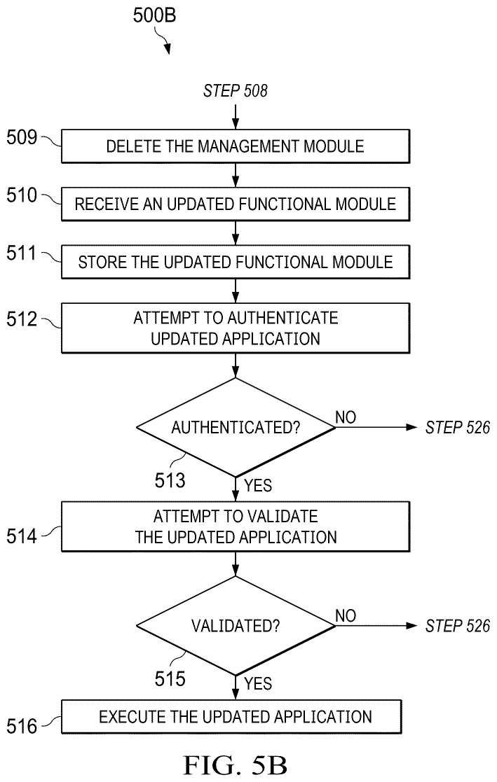

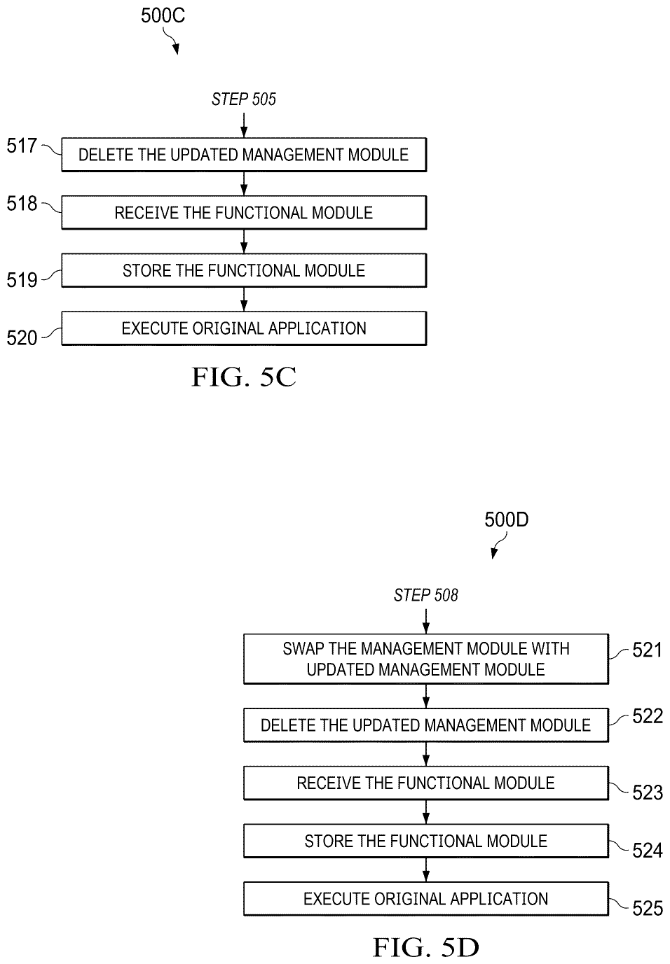

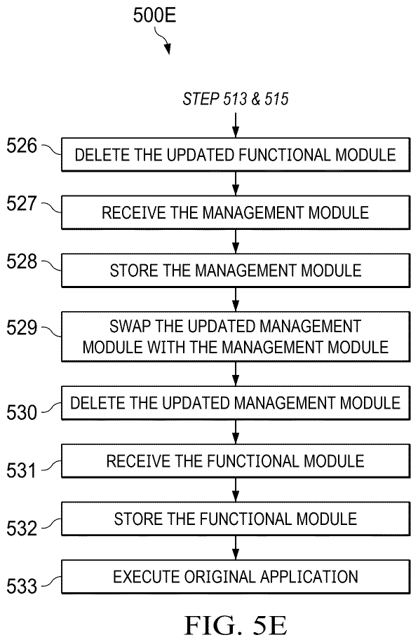

FIGS. 5A-5E illustrate software update method 500 in an implementation. Software update method 500 is representative of another technique for performing software updates that maximizes the available space in memory. Software update method 500 may be implemented in the context of hardware, firmware, or software to cause a system to operate as follows, referring parenthetically to the steps in FIGS. 5A-5E. For the purposes of explanation, software update method 500 will be explained with respect to the elements of FIG. 1. This specification is not meant to limit the applications of software update method 500, but rather to provide an example.

To begin, a user instructs processing circuitry 102 to initiate the OTA update process. For example, the user may select an update option within a companion mobile application, confirm an update prompt presented on a display, activate a dedicated hardware button, or issue an update command over a communication interface such as Wi-Fi™, Bluetooth, or UART. In response, the control software of module 111 causes processing circuitry 102 to instruct transceiver circuitry 103 to output an OTA request for updating module 111 to the external component that stores the updated application. Next, processing circuitry 102 deletes module 112 from region 109 (step 501). Simultaneously, transceiver circuitry 103 receives module 113 across the wireless network (step 502) and provides module 113 to processing circuitry 102. In response, processing circuitry 102 temporarily stores module 113 in RAM 105. Once stored, processing circuitry 102 transfers module 113 from RAM 105 to region 109 (step 503).

Next, processing circuitry 102 attempts to authenticate module 113 (step 504). For example, processing circuitry 102 checks if module 113 includes the software that enables communication with external components (step 505). If processing circuitry 102 is unable to successfully authenticate module 113, then processing circuitry 102 deletes module 113 from region 109 (step 517), later discussed in detail with reference to FIG. 5C. Alternatively, if processing circuitry 102 successfully authenticates module 113, then processing circuitry 102 swaps module 111 with module 113 (step 506). For example, processing circuitry 102 stores module 113 in a temporary location, such as RAM 105, and transfer module 111 from region 108 to region 109. Processing circuitry 102 then transfer module 113 from the temporary location to region 108.

Once transferred, processing circuitry 102 attempts to validate module 113 (step 507). In an implementation, to validate module 113, processing circuitry 102 activates the bootloader of module 110 to determine if the updated communication software of module 113 allows transceiver circuitry 103 to continue to interface with the external component that is storing the updated software (step 508). In another implementation, processing circuitry 102 utilizes a watchdog timer to validate module 113. For example, processing circuitry 102 initiates an execution of module 113 and monitors if module 113 successfully completes a predefined sequence of operations within a designated timeout period. If the sequence is not completed before the watchdog timer expires, then processing circuitry 102 determines that module 113 is invalid. Otherwise, processing circuitry 102 determines that module 113 is valid. In either case, if processing circuitry is unable to successfully validate module 113, then processing circuitry 102 swaps module 113 with module 111 (step 521), later discussed in detail with reference to FIG. 5D. Alternatively, if processing circuitry 102 successfully validates module 113, then, turning to FIG. 5B, processing circuitry 102 deletes module 111 from region 109 (step 509).

Next, the updated control software of module 113 causes processing circuitry 102 to instruct transceiver circuitry 103 to output an OTA request for updating module 112 to the external component that stores the updated application. In response, transceiver circuitry 103 receives module 114 across the wireless network (step 510) and provides module 114 to processing circuitry 102. In response to receiving module 114, processing circuitry 102 stores module 114 in RAM 105. Once stored, processing circuitry 102 transfers module 114 from RAM 105 to region 109 (step 511).

Processing circuitry 102 then attempts to authenticate the updated application (step 512). For example, processing circuitry 102 checks if modules 113 and 114 include the components for providing the desired functionality to system 100 (step 513). If processing circuitry 102 is unable to successfully authenticate the updated application, then processing circuitry 102 deletes module 114 from region 109 (step 526), later discussed in detail with reference to FIG. 5E. Alternatively, if processing circuitry 102 successfully authenticates the updated application, then processing circuitry 102 attempts to validate the updated application (step 514). For example, processing circuitry 102 activates the bootloader of module 110 to determine if modules 113 and 114 are functioning properly (step 515). Alternatively, processing circuitry 102 may utilize a watchdog timer to determine if the updated application is capable of executing a predefined sequence of operations prior to the watchdog timer expiring.

If processing circuitry 102 is unable to successfully validate the updated application, then processing circuitry 102 deletes module 114 from region 109 (step 526), later discussed in detail with reference to FIG. 5E. Alternatively, if processing circuitry 102 successfully validates the updated application, then, processing circuitry 102 begins executing the updated application from non-volatile memory 106 (step 516). For example, processing circuitry 102 executes module 113 from region 108 and executes module 114 from region 109.

Now turning to FIG. 5C, in response to processing circuitry 102 unsuccessfully authenticating module 113, processing circuitry 102 deletes module 113 from region 109 (step 517). Once deleted, processing circuitry 102 instructs transceiver circuitry 103 to output a request for restoring module 112. In response, transceiver circuitry 103 receives module 112 across the wireless network (step 518) and provides module 112 to processing circuitry 102. Processing circuitry 102 then stores module 112 in a temporary location, such as RAM 105. Once stored, processing circuitry 102 transfers module 112 from RAM 105 to region 109 (step 519). Processing circuitry 102 then returns to normal operations and executes the original application from non-volatile memory 106 (step 520). For example, processing circuitry 102 executes module 111 from region 108 and executes module 112 from region 109.

Alternatively, turning to FIG. 5D, in response to processing circuitry 102 unsuccessfully validating module 113, processing circuitry 102 swaps module 113 with module 111 (step 521). For example, processing circuitry 102 stores module 111 in a temporary location, and transfers module 113 from region 108 to region 109. Once transferred, processing circuitry 102 transfers module 111 from the temporary location to region 108. Next, processing circuitry 102 deletes module 113 from region 109 (step 522) and instructs transceiver circuitry 103 to output a request for restoring module 112. In response, transceiver circuitry 103 receives module 112 across the wireless network (step 523) and provides module 112 to processing circuitry 102. Processing circuitry 102 then stores module 112 in a temporary location, such as RAM 105. Once stored, processing circuitry 102 transfers module 112 from RAM 105 to region 109 (step 524). Processing circuitry 102 then returns to normal operations and executes the original application from non-volatile memory 106 (step 525). For example, processing circuitry 102 executes module 111 from region 108 and executes module 112 from region 109.

Conversely, turning to FIG. 5E, in response to processing circuitry 102 unsuccessfully authenticating or validating the updated application, processing circuitry 102 deletes module 114 from region 109 (step 526) and instructs transceiver circuitry 103 to output a request for restoring module 111. In response, transceiver circuitry 103 receives module 111 across the wireless network (step 527) and provides module 111 to processing circuitry 102. Processing circuitry 102 then stores modules module 111 in a temporary location, such as RAM 105. Once stored, processing circuitry 102 transfers module 111 from RAM 105 to region 109 (step 528).

Next, processing circuitry 102 swaps module 113 with module 111 (step 529). For example, processing circuitry 102 stores module 111 in a temporary location and transfers module 113 from region 108 to region 109. Processing circuitry 102 then transfers module 111 from the temporary location to region 108. Once stored by region 108, processing circuitry 102 deletes module 113 from region 109 (step 530) and instructs transceiver circuitry 103 to output a request for restoring module 112. In response, transceiver circuitry 103 receives module 112 across the wireless network (step 531) and provides module 112 to processing circuitry 102. Processing circuitry 102 then stores module 112 in a temporary location, such as RAM 105. Once stored, processing circuitry 102 transfers module 112 from RAM 105 to region 109 (step 532). Processing circuitry 102 then returns to normal operations and executes the original application from non-volatile memory 106 (step 533). For example, processing circuitry 102 executes module 111 from region 108 and module 112 from region 109.

Advantageously, software update method 500 provides another technique for updating software without dedicating a region in memory to receiving the updated software. Additionally, software update method 500 provides a technique for performing software updates that ensures reliable operation. As a result, software update method 500 provides a technique for performing OTA software updates that optimizes the available space in memory while ensuring the reliability of the software during the update process.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Circuits described herein are reconfigurable to include additional or different components to provide functionality at least partially similar to functionality available prior to the component replacement.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Modifications are possible in the described embodiments, and other embodiments are possible, within the scope of the claims.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
by one or more cores of a computing device:
executing an application from a non-volatile memory of the computing device, wherein a first portion of the application is stored in a first region of the non-volatile memory and a second portion of the application is stored in a second region of the non-volatile memory;
receiving an updated version of the first portion of the application;
overwriting the second region with the updated version of the first portion of the application;
swapping the first portion of the application with the updated version of the first portion of the application by:
storing the first portion of the application in the second region; and
storing the updated version of the first portion of the application in the first region;
receiving an updated version of the second portion of the application;
overwriting the second region with the updated version of the second portion of the application; and
executing the application from the non-volatile memory.

2. The method of claim 1, wherein overwriting the second region with the updated version of the first portion of the application includes, by the one or more cores of the computing device:
deleting the second portion of the application from the second region; and
storing the updated version of the first portion of the application in the second region.

3. The method of claim 1, wherein overwriting the second region with the updated version of the second portion of the application includes, by the one or more cores of the computing device:
deleting the first portion of the application from the second region; and
storing the updated version of the second portion of the application in the second region.

4. The method of claim 1, further comprising, in response to overwriting the second region with the updated version of the first portion of the application, authenticating the updated version of the first portion of the application by the one or more cores of the computing device.

5. The method of claim 4, wherein swapping the first portion of the application with the updated version of the first portion of the application is in response to successfully authenticating the updated version of the first portion of the application.

6. The method of claim 4, further comprising, in response to unsuccessfully authenticating the updated version of the first portion of the application, by the one or more cores of the computing device:
deleting the updated version of the first portion of the application from the second region;
receiving the second portion of the application;
storing the second portion of the application in the second region; and
executing the application from the non-volatile memory.

7. The method of claim 1, further comprising, in response to overwriting the second region with the updated version of the second portion of the application, authenticating the application by the one or more cores of the computing device.

8. The method of claim 7, further comprising, in response to unsuccessfully authenticating the application, by the one or more cores of the computing device:
receiving the first portion of the application;
overwriting the second region with the first portion of the application;
swapping the updated version of the first portion of the application with the first portion of the application by:
storing the updated version of the first portion of the application in the second region; and
storing the first portion of the application the first region;
receiving the second portion of the application;
overwriting the second region with the second portion of the application; and
executing the application from the non-volatile memory.

9. The method of claim 1, wherein:
the computing device includes a microcontroller;
the non-volatile memory includes flash memory;
the first portion of the application includes communication software; and
the updated version of the first portion of the application includes updated communication software.

10. A system comprising:
non-volatile memory including a first region configurable to store a first portion of an application and a second region configurable to store a second portion of the application;
transceiver circuitry coupled to the non-volatile memory; and
processing circuitry coupled to the non-volatile memory and the transceiver circuitry, wherein the processing circuitry is configurable to:
execute the application from the non-volatile memory;
overwrite the second region with an updated version of the first portion of the application;
swap the first portion of the application with the updated version of the first portion of the application, wherein to swap the first portion of the application with the updated version of the first portion of the application, the processing circuitry is configurable to:
store the first portion of the application in the second region; and
store the updated version of the first portion of the application in the first region;
overwrite the second region with an updated version of the second portion of the application; and
execute the application from the non-volatile memory.

11. The system of claim 10, wherein the transceiver circuitry is configurable to:
receive the updated version of the first portion of the application and the updated version of the second portion of the application over a communication network; and
provide the updated version of the first portion of the application and the updated version of the second portion of the application to the processing circuitry.

12. The system of claim 10, wherein to overwrite the second region with the updated version of the first portion of the application, the processing circuitry is configurable to:
delete the second portion of the application from the second region; and
store the updated version of the first portion of the application in the second region.

13. The system of claim 10, wherein to overwrite the second region with the updated version of the second portion of the application, the processing circuitry is configurable to:
delete the first portion of the application from the second region; and
store the updated version of the second portion of the application in the second region.

14. The system of claim 10, wherein the processing circuitry is further configurable to:
in response to overwriting the second region with the updated version of the first portion of the application, authenticate the updated version of the first portion of the application; and
in response to successfully authenticating the first portion of the application, swap the first portion of the application with the updated version of the first portion of the application.

15. The system of claim 14, wherein the transceiver circuitry is configurable to, in response to the processing circuitry unsuccessfully authenticating the updated version of the first portion of the application:
receive the second portion of the application over a communication network; and
provide the second portion of the application to the processing circuitry; and
wherein the processing circuitry is configurable to, in response to unsuccessfully authenticating the updated version of the first portion of the application:
delete the updated version of the first portion of the application from the second region;
store the second portion of the application in the second region; and
execute the application from the non-volatile memory.

16. The system of claim 10, wherein the processing circuitry is further configurable to, in response to overwriting the second region with the updated version of the second portion of the application, authenticate the application.

17. The system of claim 16, wherein the transceiver circuitry is further configurable to, in response to the processing circuitry unsuccessfully authenticating the application:
receive the first portion of the application and the second portion of the application over a communication network; and
provide the first portion of the application and the second portion of the application to the processing circuitry; and
wherein the processing circuitry is further configurable to, in response to unsuccessfully authenticating the application:
overwrite the second region with the first portion of the application;
swap the updated version of the first portion of the application with the first portion of the application, wherein to swap the updated version of the first portion of the application with the first portion of the application, the processing circuitry is configurable to:
store the updated version of the first portion of the application in the second region; and
store the first portion of the application in the first region;
overwrite the second region with the second portion of the application; and
execute the application from the non-volatile memory.

18. A non-transitory computer-readable medium storing program instructions configurable to be executed by processing circuitry, and wherein the program instructions, when executed by the processing circuitry, cause the processing circuitry to at least:
initiate an update process; and
in response to initiating the update process:
delete a second portion of an application from a second region of non-volatile memory;
download an updated version of a first portion of the application to the second region of non-volatile memory;
swap the first portion of the application, currently stored in a first region of non-volatile memory, with the updated version of the first portion of the application, wherein to swap the first portion of the application with the updated version of the first portion of the application, the program instructions cause the processing circuitry to:
store the first portion of the application in the second region of non-volatile memory; and
store the updated version of the first portion of the application in the first region of non-volatile memory;
delete the first portion of the application from the second region of non-volatile memory; and
download an updated version of the second portion of the application to the second region of non-volatile memory.

19. The non-transitory computer-readable medium of claim 18, wherein the program instructions cause the processing circuitry to:
in response to downloading the updated version of the first portion of the application to the second region of non-volatile memory, authenticate the updated version of the first portion of the application;
in response to successfully authenticating the updated version of the first portion of the application, swap the first portion of the application with the updated version of the first portion of the application; and
in response to unsuccessfully authenticating the updated version of the first portion of the application:
delete the updated version of the first portion of the application from the second region of non-volatile memory; and
download the second portion of the application to the second region of non-volatile memory.

20. The non-transitory computer-readable medium of claim 19, wherein the program instructions cause the processing circuitry to:
in response to downloading the updated version of the second portion of the application to the second region of non-volatile memory, authenticate the application; and
in response to unsuccessfully authenticating the application:
delete the updated version of the second portion of the application from the second region of non-volatile memory;
download the first portion of the application to the second region of non-volatile memory;
swap the updated version of the first portion of the application with the first portion of the application, wherein to swap the updated version of the first portion of the application with the first portion of the application, the program instructions cause the processing circuitry to:
store the updated version of the first portion of the application in the second region of non-volatile memory; and
store the first portion of the application in the first region of non-volatile memory;
delete the updated version of the first portion of the application from the second region of non-volatile memory; and
download the second portion of the application to the second region of non-volatile memory.
